(19) United States
(12) Patent Application Publication
(10) Pub. No.: US 2026/0261566 A1
(43) Pub. Date: Sep. 3, 2026

(54) SYSTEM AND METHOD FACILITATING DATA SECURITY ON A WEB NETWORKING PLATFORM

(71) Applicant: Abhishek Rawat, Kolkata (IN)

(72) Inventor: Abhishek Rawat, Kolkata (IN)

(21) Appl. No.: 19/066,177

(22) Filed: Feb. 28, 2025

(51) Int. Cl. H04L 9/40

(52) U.S. Cl. CPC H04L 63/1416

(57) ABSTRACT

The present disclosure relates to a system and a method facilitating data security on a web networking platform. The method comprises displaying, via a user interface, the web networking platform, via the user interface, a first user profile of the plurality of user profiles based at least on input of first user information, of a first user of the plurality of users, storing data associated to the first user and a series of predetermined protocols in a first memory, encoding, via execution of the series of predetermined protocols, the data associated to the first user, storing encoded data associated to the first user in a second memory, displaying, via the user interface, one of the encoded data or decoded data associated to the first user, to a second user of the plurality of users, based on the second user matching a predetermined condition.

### FIELD OF THE INVENTION

The present invention relates to the field of data security on a web networking platform, specifically focusing on secure user authentication, content encoding, and controlled access management. More specifically, the proposed system and method aims to provide a robust platform for sharing and managing user-generated content with enhanced privacy and security measures.

### BACKGROUND OF THE INVENTION

In recent years, social networking platforms have become an integral part of daily life, allowing users to share personal information, communicate with others, and form digital communities. While these platforms offer significant benefits in terms of connectivity and information sharing, they also present serious challenges related to data security and privacy. The vast amounts of personal data being shared on these platforms make them prime targets for cyberattacks, unauthorized data access, and exploitation by malicious entities.

One of the primary concerns is the inadequate protection of sensitive user data, such as personal identification information, private communications, location data, etc. Existing security mechanisms often fall short in safeguarding this information, leaving it vulnerable to breaches and leaks. This can result in identity theft, financial loss, and the unauthorized distribution of personal content, causing significant harm to users. Moreover, data breaches on social networking platforms can lead to large-scale security incidents that affect millions of users at once, further magnifying the impact of such vulnerabilities.

Furthermore, the growing sophistication of cyber threats, including phishing, hacking, and malware attacks, continues to outpace the security measures currently in place on many social networking platforms. Traditional security solutions often rely on centralized systems, which are susceptible to single points of failure. When such systems are compromised, the damage can be widespread and difficult to contain.

Given the critical nature of these issues, there is an urgent need for improved data security mechanisms that can protect user data more effectively on social networking platforms. These mechanisms should not only address current vulnerabilities but also anticipate future threats by incorporating advanced technologies and methodologies for securing data in transit, at rest, and during user interactions on the platform.

The present invention addresses these challenges by providing an enhanced data security solution specifically designed for social networking platforms. By implementing robust encryption techniques, decentralized security frameworks, and real-time monitoring systems, the invention aims to offer a comprehensive approach to safeguarding user data while preserving the seamless user experience that social networking platforms are known for.

### SUMMARY OF THE INVENTION

Before the present system and the method facilitating data security on a web networking platform is described, it is to be understood that this application is not limited to the particular system, and methodologies described, as there can be multiple possible embodiments that are not expressly illustrated in the present disclosure. It is also to be understood that the terminology used in the description is to describe the particular implementations or versions or embodiments only, and is not intended to limit the scope of the present application.

This summary is provided to introduce aspects related to the system and the method facilitating data security on a web networking platform. This summary is not intended to identify essential features of the claimed subject matter nor is it intended for use in determining or limiting the scope of the claimed subject matter.

In one implementation, a system facilitating data security on a web networking platform is described. The system comprises a processor. Further, the system comprises a user interface coupled to the processor. The processor may be configured to display the web networking platform, wherein the web networking platform includes a plurality of user profiles associated to a plurality of users, and wherein a first user profile of the plurality of user profiles is accessible based at least on input of first user information, of a first user of the plurality of users, via the user interface. Further, the system comprises a first memory coupled to the processor. The first memory may be configured to store data associated to the first user and store a series of predetermined protocols. Further, the system comprises an encoder coupled to the processor. The encoder may be configured to encode the data associated to the first user based on execution of the series of predetermined protocols. Further, the system comprises a second memory coupled to the encoder. The second memory may be configured to store encoded data associated to the first user, wherein the user interface displays, one of the encoded data or decoded data associated to the first user, to a second user of the plurality of users, based on the second user matching a predetermined condition.

In another implementation, a method facilitating data security on a web networking platform is described. The method facilitating data security on a web networking platform comprises displaying, via a user interface, the web networking platform, wherein the web networking platform includes a plurality of user profiles associated to a plurality of users. Further, the method comprises accessing, via a user interface, a first user profile of the plurality of user profiles based at least on input of first user information, of a first user of the plurality of users. Further, the method comprises storing data associated to the first user and a series of predetermined protocols in a first memory. Further, the method comprises encoding, via execution of the series of predetermined protocols, the data associated to the first user. Further, the method comprises storing encoded data associated to the first user in a second memory. Further, the method comprises displaying, via the user interface, one of the encoded data or decoded data associated to the first user, to a second user of the plurality of users, based on the second user matching a predetermined condition.

### BRIEF DESCRIPTION OF DRAWINGS

The foregoing detailed description of embodiments is better understood when read in conjunction with the appended drawings. For the purpose of illustrating the present subject matter, an example of construction of the present subject matter is provided as figures; however, the invention is not limited to the specific system and the method disclosed in the document and the figures.

FIG. 1 illustrates a network implementation (100) of a system (102) facilitating data security on a web networking platform, in accordance with an embodiment of the present subject matter;

FIG. 2 illustrates a block diagram of the system (102) facilitating data security on a web networking platform, in accordance with an embodiment of the present subject matter; and

FIG. 3 illustrates a flow diagram of a method (300) facilitating data security on a web networking platform, in accordance with an embodiment of the present subject matter.

### DETAILED DESCRIPTION OF THE INVENTION

Some embodiments of the present disclosure, illustrating all its features, will now be discussed in detail. The words “comprising”, “receiving”, “determining”, “assigning” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms "a", "an" and "the" include plural references unless the context clearly dictates otherwise. Although any systems and methods similar or equivalent to those described herein can be used in the practice or testing of embodiments of the present disclosure, the exemplary, system and method facilitating data security on a web networking platform are now described. The disclosed embodiments of the systems and the methods facilitating data security on a web networking platform are merely exemplary of the disclosure, which may be embodied in various forms.

Various modifications to the embodiment will be readily apparent to those skilled in the art, and the generic principles herein may be applied to other embodiments. However, one of ordinary skill in the art will readily recognize that the present disclosure facilitating data security on a web networking platform is not intended to be limited to the embodiments illustrated but is to be accorded the widest scope consistent with the principles and features described herein.

Generally, conventional methods and systems facilitating data security on the web platforms provide inadequate protection of sensitive user data, such as personal identification information, private communications, location data, etc., leaving it vulnerable to breaches and leaks. This results in identity theft, financial loss, and the unauthorized distribution of personal content, causing significant harm to the users. Moreover, the growing sophistication of cyber threats, including phishing, hacking, and malware attacks, continues to outpace the security measures conventionally in place on many web platforms. The conventional systems facilitating data security are configured as centralized systems that makes them susceptible to single points of failure.

The present subject matter overcomes the aforesaid problems. More specifically, problems related to data security on web platforms. The present system(s) and method(s) facilitates data security on web platforms while addressing the aforesaid problems.

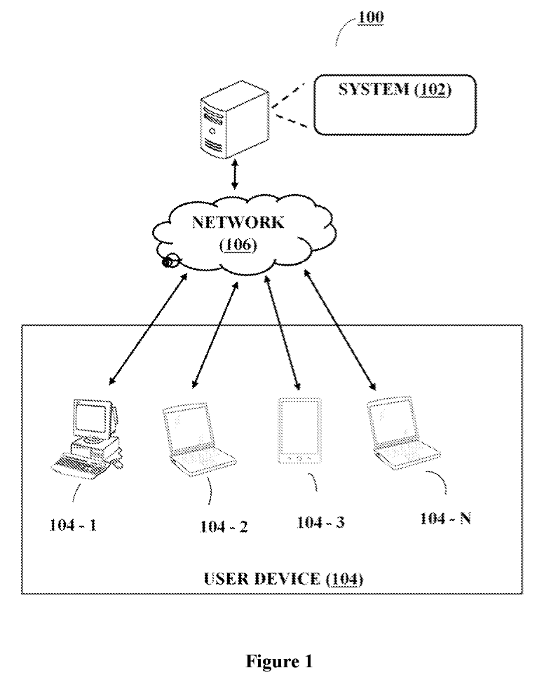

Referring now to the drawings, and more particularly to FIGS. 1 through 3, where similar reference characters denote corresponding features consistently throughout the figures, there are shown embodiments.

Referring now to FIG. 1, a network implementation of a system (102) facilitating data security on a web networking platform is disclosed. FIG. 1 shows user devices, interconnection between the devices, generation of data or usage across multiple platforms and the network facilitating data security on a web networking platform, processing and network element in order to keep the speed, cost and quality optimized. In one example, the system 102 may be connected with user devices 104-1 through 104-N (collectively referred as 104) through a communication network (106).

It should be understood that the system (102) and the user devices (104) correspond to computing devices. It may be understood that the system (102) may also be implemented in a variety of computing systems, such as a laptop computer, a desktop computer, a notebook, a workstation, a mainframe computer, a server, a network server, a cloud-based computing environment, or a smart phone and the like. It may be understood that the mobile devices (104) may correspond to a variety of portable computing devices, such as a laptop computer, a desktop computer, a notebook, a smart phone, a tablet, a phablet, and the like.

In one implementation, the communication network (106) may be a wireless network, a wired network, or a combination thereof. The communication network (106) can be implemented as one of the different types of networks, such as intranet, Local Area Network (LAN), Wireless Personal Area Network (WPAN), Wireless Local Area Network (WLAN), wide area network (WAN), the internet, and the like. The communication network 106 may either be a dedicated network or a shared network. The shared network represents an association of the different types of networks that use a variety of protocols, for example), Hypertext Transfer Protocol (HTTP), Transmission Control Protocol/Internet Protocol (TCP/IP), and the like, to communicate with one another. Further, the communication network (106) may include a variety of network devices, including routers, bridges, servers, computing devices, storage devices, and the like.

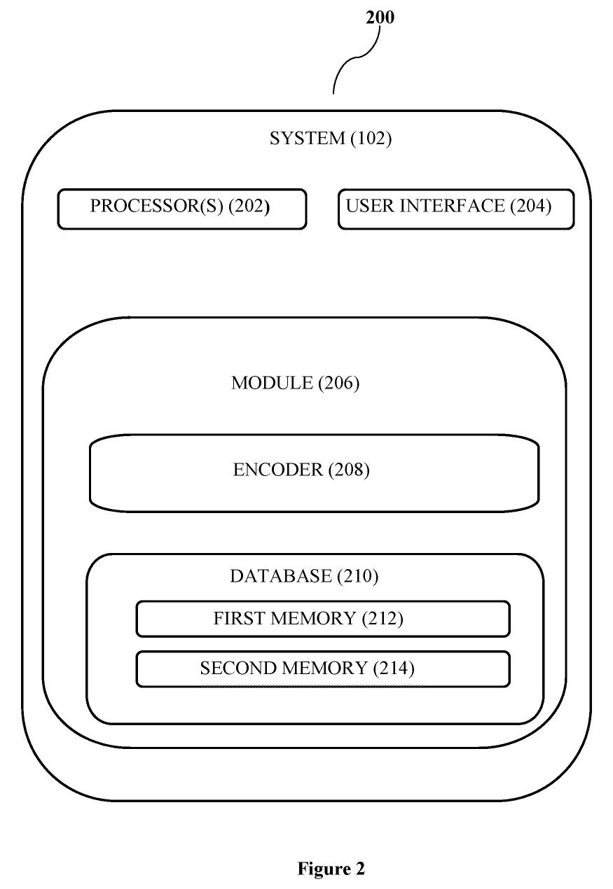

Referring now to FIG. 2, a block diagram (200) of the system (102) is illustrated in accordance with an embodiment of the present subject matter, more specifically FIG. 2 illustrates high level components of the system (102). In an example, a user interface (204) for end user interaction and where data generation triggers, a processor (202) for initial processing and data cleansing, an encoder (208) for encoding data associated with one or more users, and all the storage, analytics, transformation on collected and derived datasets are performed in database (210). In one embodiment, the system (102) may include the processor (202), the user interface (204) (may also as referred to input/output (I/O) interface), the encoder (208), the database (210), and graphics processing unit (GPU) (not shown). The processor (202) may be implemented as one or more microprocessors, microcomputers, microcontrollers, digital signal processors, central processing units, state machines, logic circuitries, and/or any devices that manipulate signals based on operational instructions. Among other capabilities, the at least one processor (202) may be configured to fetch and execute computer-readable instructions stored in the database (210).

The user interface (204) may include a variety of software and hardware interfaces, for example, a web interface, a graphical user interface, a command line interface, and the like. The user interface (204) may allow a user to interact with the system (102). Further, the user interface (204) may enable the system (102) to communicate with the user devices (104), and other computing devices, such as web servers and external data servers (not shown). The user interface (204) can facilitate multiple communications within a wide variety of networks and protocol types, including wired networks, for example, LAN, cable, etc., and wireless networks, such as WLAN, cellular, or satellite. The user interface (204) may include one or more ports for connecting a number of devices to one another or to another server.

The database (210), amongst other things, serves as a repository for storing data processed, received, and generated by one or more of modules (206) and/or the encoder (208). The database (210) includes a first memory layer (212) and a second memory layer (214). The first memory layer (212) and the second memory layer (214) may include any computer-readable medium or computer program product known in the art including, for example, volatile memory, such as Static Random Access Memory (SRAM) and Dynamic Random Access Memory (DRAM), and/or non-volatile memory, such as Read Only Memory (ROM), Erasable Programmable ROM (EPROM), Electrically Erasable and Programmable ROM (EEPROM), flash memories, hard disks, optical disks, and magnetic tapes.

The database (210) may include data generated as a result of the execution of one or more of the modules (206) and/or the encoder (208). The modules (206) may comprise plurality of modules. The plurality of modules may comprise a metadata crawler, a defining module, an analyzing module, a rule engine, storage layer, a transformation and aggregation/ computation module, a data sharing module, a compliance and privacy component. The plurality of modules may be configured to execute the set of instructions and are not shown in FIG. 2.

Optionally, the database (210) may be hosted over elastic compute cloud (ec2). Further, optionally, the database (210) may be one of a relational database service, a simple storage service (s3) with content delivery network (CDN) enabled, or any combination of the aforesaid.

In an embodiment, the system (102) may be configured to facilitate data security on a web networking platform. The system (102) comprises the processor (202), the user interface (204) coupled to the processor (202), the first memory layer (212) coupled to the processor (202), the encoder (208) coupled to the processor (202), and the second memory layer (214) coupled to the encoder (208) and simultaneously coupled to the processor (202).

The user may enter a user input through the user interface (204) on the web networking platform. More specifically, the user may input a specific type of information and/or may upload a specific type of data through the user interface (204) on the web networking platform. The first memory layer (212) is configured to store the specific type of information and/or the specific type of data related to the user. Additionally, the first memory layer (212) is configured to store advanced imaging protocols which when executed by the processor (202) causes the processor (202) to control the encoder (208) to encode the specific type of information and/or the specific type of data. The second memory layer (214) is configured to store encoded data and/or encoded information related to the user.

In an embodiment, the specific type of information includes at least information pertaining to the user such as but not limited to user’s name, user’s age, user’s gender, user’s contact details, etc. Moreover, the specific type of data includes at least images of the user including facial images, videos of the user, documents related to the user, etc.

In an embodiment, the user interface (204) includes a plurality of icons such as create a new user profile, login, logout, settings, etc.

In an embodiment, the advanced imaging protocols includes execution of various functionalities such as but not limited to blurring, retouching, compositing, colour correction, cropping, resizing, exposure adjustment, sharpening, adding filters and/or effects to the images associated to the user or the videos associated to the user.

The processor (202) is further configured to control the user interface (204) to display, either the encoded data or the decoded data related to the user, to another user. The encoded data related to the user is displayed to the another user at least when the another user has not made a monetary transaction over the web networking platform. In contrary, the decoded data related to the user is displayed to the another user at least when the another user has made a monetary transaction over the web networking platform.

In an embodiment, the decoded data related to the user is displayed to the another user, when the another user has made the monetary transaction over the web networking platform, only for a stipulated timeline (e.g. for 6 months or a year but not more than that). It should be noted that in case the user has added new content subsequent to the transaction being made by the another user, the another user needs to make a subsequent transaction over the web networking platform to get access to the newly added content of the user.

In an embodiment, the processor (202) is further configured to control the user interface (204) to display either the encoded data or the decoded data related to the user, to the another user at least based on specific instructions received from the user. For example, the user may choose to hide his/her details not merely from a free user but from a paid user as well. The user may input specific instructions such as hide his/her respective profile and/or a specific information from a particular user. Accordingly, the processor (202) is configured to comply with the said instructions of the user by controlling the user interface (204) to display in accordance with the said instructions.

In an embodiment, the user may access his/her profile on the web networking platform subsequent to receiving a notification in a form but not limited to textual notification and/or sound notification.

In an embodiment, the system (102) allows the users to communicate with one another via textually and/or voice call. The system (102) allows the users from different locations to communicate with each other even when the users don’t understand a common language. Suppose an individual whose native language is Japanese may interact, via the system (102), with another individual who is not aware of the Japanese language, efficiently. In such a scenario, the system (102), via the processor (202), first identifies a form of dialect in a text written by the individual and/or recognize the form of dialect in a speech made by the individual. Thereafter, the processor (202) converts, in real-time, the form of dialect into another specific form of the dialect that is convenient or native to another individual that eventually makes the individuals better understand each other and to efficiently communicate with each other over the web networking platform.

The functionality of conversion of the dialect works in a similar manner as stated above even if the individuals are connected via a video call. However, for the individual to connect to another individual via the video call, the individual needs to make a monetary transaction over the web networking platform.

The form of dialect in the text or the speech is identified or recognized by a computer module and/or a foundation model (e.g. AI model).

It is pertinent to mention that one individual can connect with infinite number of other individuals over the platform. Initially, the individual attempts to connect with the another individual via a digital gesture such as poke/ nudge over the platform, wherein the digital gesture is transmitted based on a user input via the system (102). It is to be noted that transmission of the digital gesture is limited in number (e.g. 20 to 40 per day).

It is also pertinent to mention that once the monetary transaction is made over the platform by the user, the system (102) credits specific number of tokens, depending on an amount of the monetary transaction being made, to a digital wallet (associated to the platform) of the user. The tokens are used in form of money and gets deducted on the basis of connections being made by the user with different users via digital gestures etc., communicating with the other users via video, audio, and/or textual, viewing of the decoded data related to the other users, etc.

In another exemplary embodiment, the processor (202) is further configured to control the user interface (204) to display, either the encoded data or the decoded data related to the user, to another user. The encoded data related to the user is displayed to the another user at least when the another user is associated to the web networking platform, as a free member. In contrary, the decoded data related to the user is displayed to the another user at least when the another user is associated to the web networking platform, as a paid member. Moreover, the user becomes the paid member by making a monetary transaction over the web networking platform.

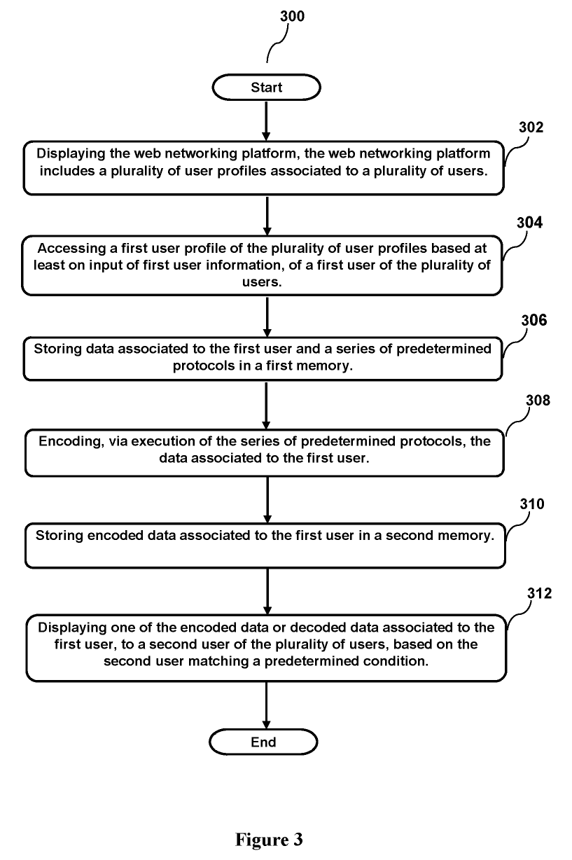

In another exemplary embodiment, referring to FIG. 3, a method (300) facilitating data security on a web networking platform is shown. The method (300) may be executed in the system (102).

The order in which the method (300) facilitating data security on a web networking platform is described is not intended to be construed as a limitation, and any number of the described method blocks may be combined/performed in any order, repetitively, iteratively or simultaneously to implement the method (300) or alternate methods. Additionally, individual blocks may be deleted from the method (300) without departing from the spirit and scope of the subject matter described herein. Further, the method (300) may be implemented in any suitable hardware, software, firmware, or combination thereof. However, for ease of explanation, in the embodiments described below, the method (300) may be considered to be implemented in the above-described system (102).

The method (300) may be executed in the system (102). At step 302, the method (300) provides displaying the web networking platform including a plurality of user profiles associated to a plurality of users.

At step 304, the method (300) provides accessing a user profile of the plurality of user profiles based at least on input of user information, of a user of the plurality of users.

At step 306, the method (300) provides storing data associated to the user and a series of advanced imaging protocols in the first memory layer (212).

At step 308, the method (300) provides encoding, via execution of the series of advanced imaging protocols, the data associated to the user.

At step 310, the method (300) provides storing the encoded data associated to the user in the second memory layer (214).

At step 312, the method (300) provides displaying one of the encoded data or the decoded data associated to the user, to the another user, based on the another user matching a predetermined condition.

The foregoing description of the specific embodiments will so fully reveal the general nature of the embodiments herein that others can, by applying current knowledge, readily modify and/or adapt for various applications such specific embodiments without departing from the generic concept and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system facilitating data security on a web networking platform, comprising:
a processor;
a user interface coupled to the processor, wherein the user interface is configured to display the web networking platform, wherein the web networking platform includes a plurality of user profiles associated to a plurality of users, and wherein a first user profile of the plurality of user profiles is accessible based at least on input of first user information, of a first user of the plurality of users, via the user interface;
a first memory coupled to the processor, wherein the first memory is configured to:
store data associated to the first user; and
store a series of predetermined protocols;
an encoder coupled to the processor, wherein the encoder is configured to encode the data associated to the first user based on execution of the series of predetermined protocols; and
a second memory coupled to the encoder, wherein the second memory is configured to store encoded data associated to the first user, wherein the user interface displays, one of the encoded data or decoded data associated to the first user, to a second user of the plurality of users, based on the second user matching a predetermined condition.

2. The system according to claim 1, wherein the data associated to the first user includes at least one of a plurality of images, a plurality of videos, or a plurality of documents.

3. The system according to claim 1, wherein the user interface is configured to display the encoded data to the second user based on one of non-execution of a monetary transaction or failure of the monetary transaction over the web networking platform by the second user.

4. The system according to claim 1, wherein the user interface is configured to display the decoded data to the second user based on execution of a monetary transaction over the web networking platform by the second user.

5. The system according to claim 1, wherein the user interface is configured to display the encoded data to the second user based at least on a predetermined input of the first user via the user interface.

6. The system according to claim 1, wherein the user interface is configured to display the decoded data to the second user based at least on a predetermined input of the first user via the user interface.

7. The system according to claim 1, wherein the predetermined protocols correspond to imaging protocols, wherein the processor is configured to execute the imaging protocols, and wherein the imaging protocols includes at least one of blurring a set of facial images of a plurality of images associated to the first user or blurring a set of videos of a plurality of videos associated to the first user.

8. The system according to claim 1, wherein the user interface includes a plurality of icons including at least one of create a new user profile, login, or logout.

9. The system according to claim 1, wherein the first user profile is accessible based on a notification, including a predetermined information, received by the first user and input of the predetermined information, via the user interface.

10. A method facilitating data security on a web networking platform, the method comprising:
displaying, via a user interface, the web networking platform, wherein the web networking platform includes a plurality of user profiles associated to a plurality of users;
accessing, via the user interface, a first user profile of the plurality of user profiles based at least on input of first user information, of a first user of the plurality of users;
storing data associated to the first user and a series of predetermined protocols in a first memory;
encoding, via execution of the series of predetermined protocols, the data associated to the first user;
storing encoded data associated to the first user in a second memory; and
displaying, via the user interface, one of the encoded data or decoded data associated to the first user, to a second user of the plurality of users, based on the second user matching a predetermined condition.

11. The method according to claim 10, wherein the data associated to the first user includes at least one of a plurality of images, a plurality of videos, or a plurality of documents.

12. The method according to claim 10, further comprising displaying, via the user interface, the encoded data to the second user based on one of non-execution of a monetary transaction or failure of the monetary transaction over the web networking platform by the second user.

13. The method according to claim 10, further comprising displaying, via the user interface, the decoded data to the second user based on execution of a monetary transaction over the web networking platform by the second user.

14. The method according to claim 10, further comprising displaying, via the user interface, the encoded data to the second user based at least on a predetermined input of the first user via the user interface.

15. The method according to claim 10, further comprising displaying, via the user interface, the decoded data to the second user based at least on a predetermined input of the first user via the user interface.

16. The method according to claim 10, wherein the predetermined protocols correspond to imaging protocols, wherein a processor executes the imaging protocols, and wherein the imaging protocols includes at least one of blurring a set of facial images of a plurality of images associated to the first user or blurring a set of videos of a plurality of videos associated to the first user.

17. The method according to claim 10, wherein the first user profile is accessible based on a notification, including a predetermined information, received by the first user and input of the predetermined information, via the user interface.
